(19) United States
(12) Patent Application Publication
(10) Pub. No.: US 2022/0391855 A1
(43) Pub. Date: Dec. 8, 2022

(54) METHOD, SYSTEM AND APPARATUS THEREOF, FOR MAINTENANCE OF DATA IN HIGH-AVAILABILITY DATA CENTER

(71) Applicant: Flipkart Internet Private Limited, Karnataka (IN)

(72) Inventors: Jain JOHNY, Karnataka (IN); Anuj AGRAWAL, Karnataka (IN); Shubham GUPTA, Haryana (IN)

(21) Appl. No.: 17/831,010

(22) Filed: Jun. 2, 2022

(30) Foreign Application Priority Data
Jun. 2, 2021 (IN) 202141024605

(51) Int. Cl. G06Q 10/00

(52) U.S. Cl. CPC G06Q 10/20

(57) ABSTRACT

A method for grouping data in a data center into one or more maintenance domains (MD) which then processed, copied and mirror hosted as one or copies of maintenance domain. Each application running in the data center is evenly distributed across the MDs. For an maintenance one or more copy of the MD is updated and changes propagated through the copies of hosted MD. Thus, successfully shutting down only one or more MD for maintenance without affecting the availability of entire data center.

### FIELD

Execution of planned maintenances on a large fleet of IT devices in a data center

### BACKGROUND

Data Center is a building with dedicated space within a building, or a group of buildings used to house computer systems and associated components, such as network and storage systems. In data-center architecture, the data is centralized and accessed frequently by other components, which modify data. Data-center architecture consists of different components that communicate through shared data repositories. The components access a shared data structure and are relatively independent, in that, they interact only through the data store.

Data centers require continuous maintenance, however conducting any large scale data center (DC) maintenance has two main challenges. Firstly, the time taken to finish the maintenance in the entire DC has to be predictable. Secondly, the impact to application clusters and data replicas in the DC has to be predictable.

With advent of cloud hosting where multiple application from various services providers may be hosted by a cloud service provider. It will be beneficial to save application in a data center which is designed such that various components are grouped into segments whose downtime for maintenance or update can be predicted so that an agreed service level agreements are maintained.

### SUMMARY

According to one or more embodiments of the present invention disclosed is a method for operating a data center (DC), the method comprising: receiving one or more application having one or more objects and allocation requirements, wherein a datacenter controller specifying allocation requirements and placing one or more objects and allocations requirements of the one or more application on one or more maintenance domain in the data center, wherein one or more objects and allocation requirements of one or more application is mapped to one or more maintenance domains predefined in the data center; grouping one or more maintenance domain (MD) onto a static maintenance domain out of one or more static maintenance domain (SMD), wherein SMD represent a group of MDs on which an operation is performed without affecting the operation of other SMD. Wherein MDs are mapped to one or more physical entities corresponding the the one or more maintenance domain. Wherein the smallest maintenance unit of the data center is the smallest group of devices such as processors, storage devices, network devices, power supply, such that a downtime on any device in the SMD causes a downtime only to the one or more MDs within that SMD. Wherein one or more SMD represents a logical collection of one or more MD that are imperative for operation of one or more application and the different SMD are predefined while defining the data center. Wherein number of MDs are fixed and the data center is contained fully within a predefined fixed number of MDs. Wherein the MDs are visible to the one or more application via constructs.

According to one or more embodiments of the present invention disclosed is an application data storing and processing system, comprising, a data center controller, defining one or more maintenance domain, wherein on receiving one or more application having one or more objects and allocation requirements, placing one or more objects and allocation requirements of the one or more application on one or more maintenance domain in the data center based on MD specification, a static domain controller, grouping one or more maintenance domain onto a static maintenance domain (SMD) out of one or more SMD. Further, mapping, by the data center controller, MDs to one or more physical entities corresponding the one or more maintenance domain. Wherein maintenance domain (MD) is group of devices of a data center such as processors, storage devices, network devices, power supply, such that a downtime on any device in the SMD causes a downtime only to the one or more MDs within that SMD.

### DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise. The use of “including”, “comprising”, or “having” and variations thereof herein is meant to encompass the items listed thereafter and equivalents thereof as well as additional items.

Reference will now be made in detail to the example embodiments, as illustrated in the accompanying drawings. Whenever possible, the same reference numerals will be used throughout the drawings to refer to the same or like parts. Furthermore, and as described in subsequent paragraphs, the specific configurations illustrated in the drawings are intended to exemplify embodiments of the disclosure and that other alternative configurations are possible.

The following explanation will help with the understanding of the present invention, these descriptions are not limiting but rather explanatory, Top of the Rack Switch (ToR switch): The network switch to which all servers in a rack are connected. JBOD: Just a Bunch Of Disks—an enclosure of multiple disks which may be connected to one or more servers. Fault Domain (FD): A group of devices which are connected to a common single point of failure (SPOF) in a DC. A downtime of the SPOF causes downtime in all the devices connected to it. e.g., servers connected to a single ToR switch.

In the present disclosure a Maintenance Domain (MD) can be understood as a group of devices in a DC which may be taken down together for a planned maintenance and a Static Maintenance Domain (SMD) is also a type of MD which in the context of this invention is termed as SMD to differentiate from other methods of dynamically grouping devices.

For the impact to stateless application clusters to be predictable, we need to ensure that each application running in the DC and its related and dependent devices and components are contained within one MDs. For the impact of data replicas to be predictable, it is ensured that the MDs are known at the time of storing the data/application so that the replicas can be distributed among different MDs. The application deployment should be fully contained in a MD.

Disclosed is an application saving method where the application is saved as a Fixed deployment (FD) contained in a MD. While undertaking maintenance one or more MD is updated.

The present disclose relates to storing applications in a data center which is logically and sometime physically built in a manner that helps in separation of various components of to data center to achieve predictable down-time of application(s) or a static maintenance domains (SMD). The smallest unit of a SMD is defined as maintenance unit (MU); the data center (DC) it self is defined in terms of multiple maintenance domains (MDs).

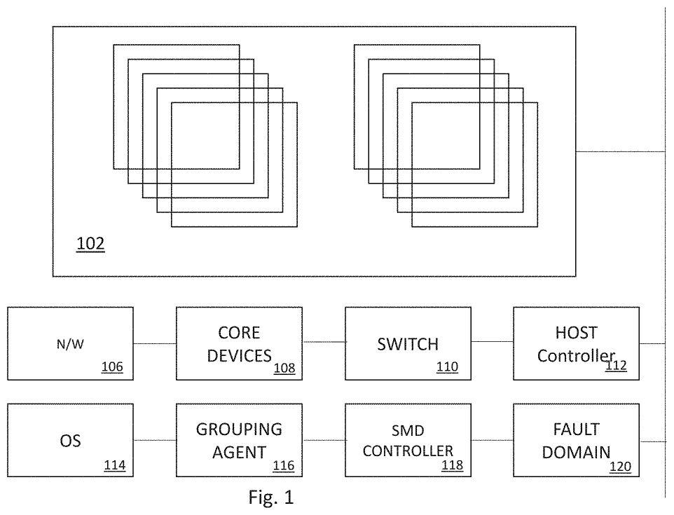

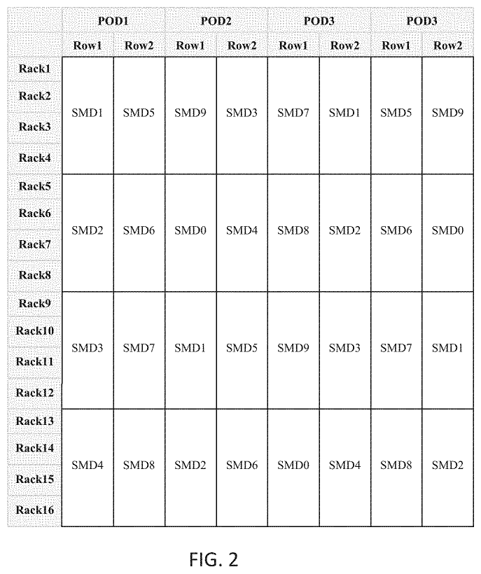

As disclosed in FIG. 1, multiple JBODs (102) are placed on different racks (Rack 1 . . . Rack 16 disclosed in FIG. 2) of a data center, other devices in the DC may include one or more other hardware devices (106), cored devices (108), switch(s) (110), host controller (112), operating system (114), grouping agent (116), SMD controller (118), Fault domain (120). These components are either hardware and or software or a combination, which are well known in the art. The SMD controller the number of SMDs in the DC and the grouping agent groups the various JBODs (102) arranged on racks into maintenance units or MU. The fault domain (120), controller grouping of MU or MD into different SMDs. Before any application and its related dependences are logically or physically grouped, the SMD controller directs the division of MU into multiple groups which includes JBODs (102), switch (110), H/W (106) or hardware 106.

FIG. 2 discloses an exemplified arrangement of various SMDs (SMD0-SMD9), the JBODs are placed in a rack (Rack 1-Rack 16) and row (Row 1-Row2) in pods (POD 1-POD 4) arrangement. The number of SMDs are calculated as i modulo N, where ‘i’ is the ordinal number of the maintenance unit and N is the number of SMDs we need in the DC. The N can be decided by the cloud provider or service provider.

The maintenance unit is that smallest unit of a DC, which are grouped together to form a MD. The smallest maintenance unit of the DC is the smallest group of devices (compute, storage, network, power supply etc.) grouped in such a way that a downtime on any device in that group causes a downtime only to the devices within that group. For example, a ToR switch, the servers connected to it and any JBODs connected to those servers. If JBODs are connected to servers across two ToRs, then the smallest unit consists of both the ToRs, all servers connected to those ToRs and all JBODs connected to those servers. Further, all types of devices are uniformly distributed in each of the units. It may be noted that, if maintenance on a device does not cause downtime to any other device, it may be excluded from the maintenance unit described above for example, if all servers are connected to two ToR switches for high availability, doing maintenance on each ToR switch does not cause downtime and hence they do not have to be part of the maintenance units. Thus, a fault domain is contained within a maintenance unit and a maintenance unit may contain multiple fault domains.

The maintenance unit (MU) are grouped into fixed number (N) of static maintenance domain (SMD). The number of SMDs are decided before hand by an administrator based on requirements. A The application are thus required to be copied across the SMDs as fault domains which are contained in a SMD. The SMDs can be further grouped for hosting fail over copies of the application. The DC can be configured to have any number of SMD as long as required SLA is maintained.

The optimal number of maintenance domains (MD) can be calculated by dividing the number of components of a type equally or unequally among different MDs. Further, let's say X is the number of maintenance units in a given DC, and n is the number of SMDs required to cover maintenance on the entire DC to keeping impact percentage less that 5%. Then,
(X₁+X₂+Xᵢ . . . Xₙ)=X Xᵢ is the number of units in i^{th} MD.
each Xᵢ=(a*X)/100<(5*X)/100
means, n*(a*X)/100<n*(5*X)/100
i.e. n*(a*X)/100=X<n*(5*X)/100
i.e. n=100/a where a<5,
a is a natural number, so max a=4 satisfies.
N=25, means keeping 25 MDs we can do maintenance on the entire DC, irrespective of the number of units in the DC, honoring the max 5% unavailability SLA.

In an embodiment the present disclosure is utilized by cloud service providers when they have to do large fleet maintenance like security patches or software and hardware upgrades. By deciding the SMD grouping upfront while designing the DC and by setting an expectation with tenants that 1 SMD will be down for maintenance at time, they can ensure that the maintenance will be completed in a predicted timeframe and the impact to the tenant is predictable irrespective of the scale of maintenance.

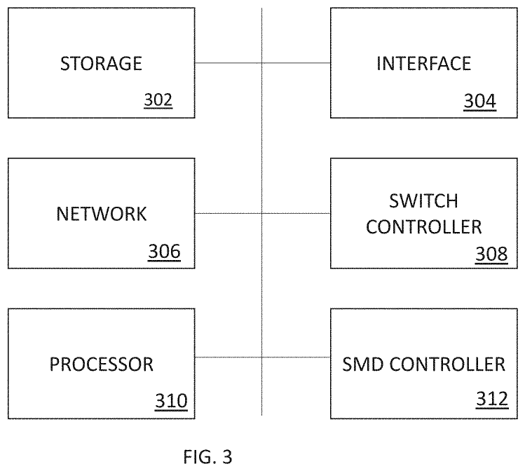

FIG. 3 discloses configuration of a data center, a person killed in the art realizes that the disclosed components and other undisclosed components can be interchangeable used for realizing the Data center's operations, thus apart from storage 302, interface 304, network 306, switch controller 308, processor 310 and SMD controller 312, other components are utilized in the present invention.

A person skilled in the art will realize that the above described techniques may be implemented using multiple camera systems also, where feed from multiple camera system my be processed by the VloS-IPS system for localizing and identifying the bots.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

We claim:

1. A method for operating a data center (DC), the method comprising:
receiving one or more application having one or more objects and allocation requirements, wherein a datacenter controller specifying allocation requirements and placing one or more objects and allocations requirements of the one or more application on one or more maintenance domain in the data center, wherein one or more objects and allocation requirements of one or more application is mapped to one or more maintenance domains predefined in the data center;
grouping one or more maintenance domain (MD) onto a static maintenance domain out of one or more static maintenance domain (SMD), wherein SMD represent a group of MDs on which an operation is performed without affecting the operation of other SMD.

2. The method as claimed in claim 1, wherein MDs are mapped to one or more physical entities corresponding the one or more maintenance domain.

3. The method as claimed in claim 1, wherein the smallest maintenance unit of the data center is the smallest group of devices such as processors, storage devices, network devices, power supply, such that a downtime on any device in the SMD causes a downtime only to the one or more MDs within that SMD.

4. The method as claimed in claim 1, wherein one or more SMD represents a logical collection of one or more MD that are imperative for operation of one or more application and the different SMD are predefined while defining the data center.

5. The method as claimed in claim 1, wherein number of MDs are fixed and the data center is contained fully within a predefined fixed number of MDs.

6. The method as claimed in claim 1, wherein the MDs are visible to the one or more application via constructs.

7. An application data storing and processing system, comprising;
a data center controller, defining one or more maintenance domain, wherein on receiving one or more application having one or more objects and allocation requirements, placing one or more objects and allocation requirements of the one or more application on one or more maintenance domain in the data center based on MD specification;
a static domain controller, grouping one or more maintenance domain onto a static maintenance domain (SMD) out of one or more SMD.

8. The system as claimed in claim 7, comprises:
mapping, by the data center controller, MDs to one or more physical entities corresponding the one or more maintenance domain.

9. The system as claimed in claim 7, comprises:
maintenance domain (MD) which is group of devices of a data center such as processors, storage devices, network devices, power supply, such that a downtime on any device in the SMD causes a downtime only to the one or more MDs within that SMD.
